(19) United States
(12) Patent Application Publication
(10) Pub. No.: US 2015/0075411 A1
(43) Pub. Date: Mar. 19, 2015

(54) INCINERATOR

(71) Applicant: JOSEF SHTURMAN, HADERA (IL)

(72) Inventor: JOSEF SHTURMAN, HADERA (IL)

(21) Appl. No.: 14/296,517

(22) Filed: Jun. 5, 2014

Related U.S. Application Data
(60) Provisional application No. 61/831,645, filed on Jun. 6, 2013.

(51) Int. Cl. F23G 5/26; F23G 5/44; F27D 1/00; F23G 5/00

(52) U.S. Cl. CPC F23G 5/26; F23G 5/002; F23G 5/442; F27D 1/00
USPC 110/346; 110/248; 110/259; 110/323

(57) ABSTRACT

An incinerator including an incineration chamber; a chamber wall having a first insulating material for retaining heat in the incineration chamber, the insulating material being mounted on the lower portion of the chamber wall, and a second insulating material for allowing a portion of the heat to radiate from the incineration chamber, the second insulating material being mounted on the upper portion of the chamber wall, the chamber wall further defining at least one hot air inlet for allowing hot air to enter the incineration chamber and at least one incineration gases outlet for allowing hot gases to exit from the incineration chamber a dividing wall disposed around the chamber wall, thereby defining a gas space between the chamber wall and the dividing wall, and at least one gas outlet for allowing hot gas to pass from the gas space; an exterior wall disposed around the dividing wall, thereby defining an air space between the dividing wall and the exterior wall, the exterior wall further defining at least one ambient air inlet for allowing ambient air to enter the air space, the chamber wall further defining at least one hot air inlet for allowing hot air to pass from an air space to the incineration chamber; a sealable feeding fuel inlet; a bottom wall defining an ashes outlet; a first limiting bottom wall disposed between portions of the chamber wall and the dividing wall for limiting said gases space; a second limiting bottom wall disposed between portions of the dividing wall and the exterior wall for limiting the air space; a grate disposed in the ashes outlet in the bottom wall for allowing ashes to pass therethrough; a floor disposed under the grate for collecting the ashes for removal; wherein, fuel fed through the fuel inlet is incinerated in the incineration chamber, ambient air entering the air space, which is heated by the chamber wall, enters the incineration chamber through the hot air inlet in the chamber wall and contributes to the incineration process, incineration gases which are formed by the incineration exit the incineration chamber into said gases space through the incineration gases outlet in the chamber wall, exit the gases space for collection through the gas outlet in the chamber wall and the gas outlet in the exterior wall, and ashes formed by the incineration pass through the grate onto the floor for removal.

### FIELD OF THE INVENTION

The present invention relates to incinerators, in general, and, in particular, to incinerators for burning refuse and producing gas.

### BRIEF DESCRIPTION OF THE DRAWINGS

The present invention will be further understood and appreciated from the following detailed description taken in conjunction with the drawing in which:

FIG. 1 is a schematic sectional side view of an incinerator, constructed and operative in accordance with one embodiment of the present invention;

FIG. 2 is an isometric view of an exemplary incinerator, constructed and operative in accordance with one embodiment of the present invention;

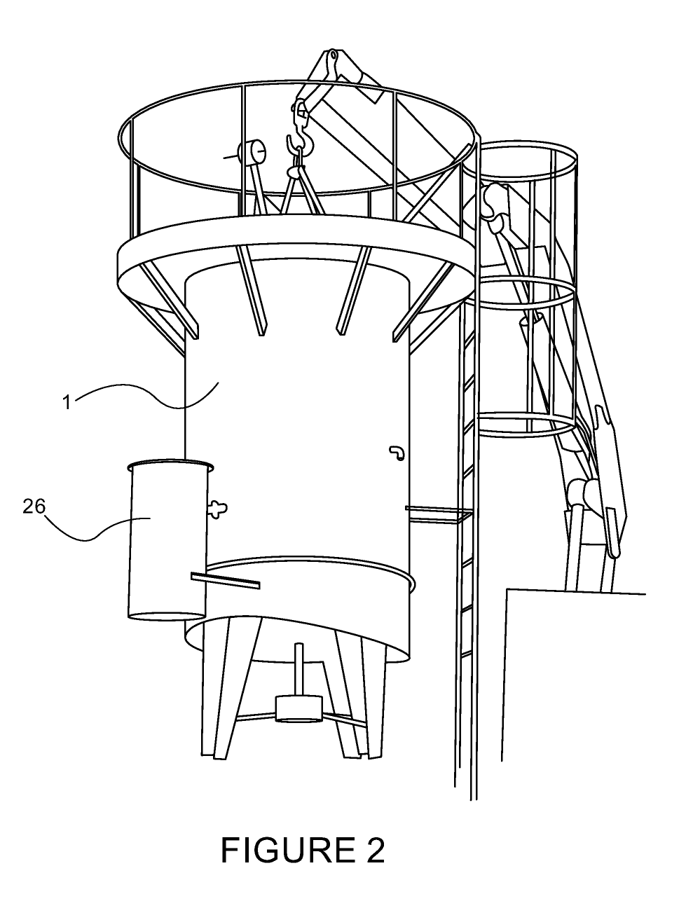

FIG. 3 is an isometric view of a slanted rotating grate in the incinerator of FIG. 2; and

FIG. 4 is a plan view of the incinerator of FIG. 2.

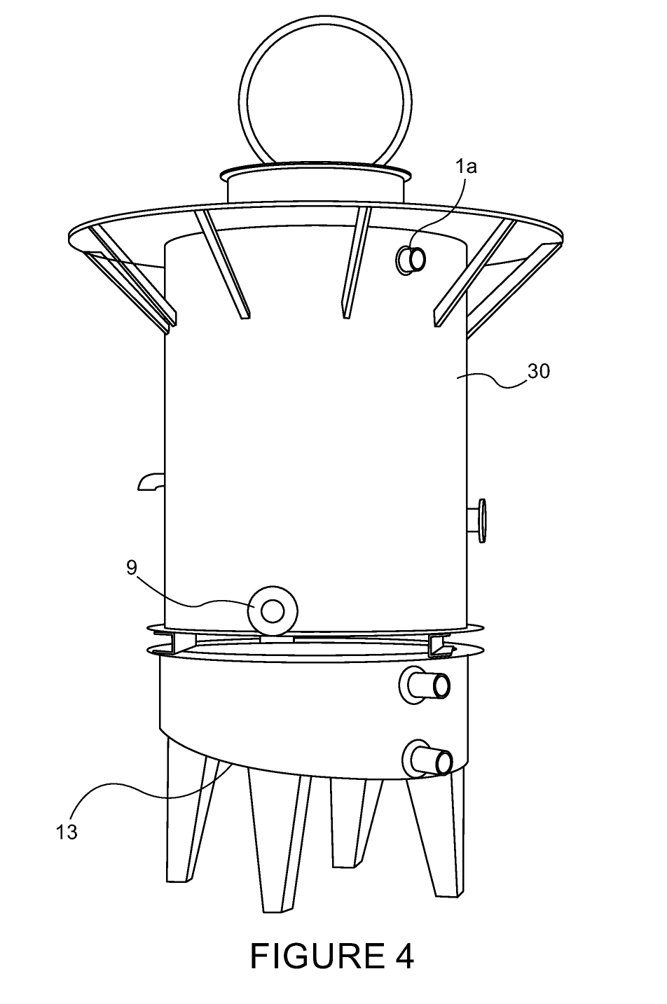

### SUMMARY OF THE INVENTION

The present invention relates to an incinerator including an incineration chamber; a chamber wall having a first insulating material for retaining heat in the incineration chamber, the insulating material being mounted on the lower portion of the chamber wall, and a second insulating material for allowing a portion of the heat to radiate from the incineration chamber, the second insulating material being mounted on the upper portion of the chamber wall, the chamber wall further defining at least one hot air inlet for allowing hot air to enter the incineration chamber and at least one incineration gases outlet for allowing hot gases to exit from the incineration chamber, a dividing wall disposed around the chamber wall, thereby defining a gas space between the chamber wall and the dividing wall, and at least one gas outlet for allowing hot gas to pass from the gas space. An exterior wall is disposed around the dividing wall, thereby defining an air space between the dividing wall and the exterior wall, the exterior wall further defining at least one ambient air inlet for allowing ambient air to enter the air space, the chamber wall further defining at least one hot air inlet for allowing hot air to pass from an air space to the incineration chamber. The incinerator further includes a sealable feeding fuel inlet; a bottom wall defining an ashes outlet; a first limiting bottom wall disposed between portions of the chamber wall and the dividing wall for limiting said gases space; and a second limiting bottom wall disposed between portions of the dividing wall and the exterior wall for limiting the air space. A grate is disposed in the ashes outlet in the bottom wall for allowing ashes to pass therethrough and a floor is disposed under the grate for collecting the ashes for removal. Fuel fed through the fuel inlet is incinerated in the incineration chamber, ambient air entering the air space, which is heated by the chamber wall, enters the incineration chamber through the hot air inlet in the chamber wall and contributes to the incineration process, incineration gases which are formed by the incineration exit the incineration chamber into said gases space through the incineration gases outlet in the chamber wall, exit the gases space for collection through the gas outlet in the chamber wall and the gas outlet in the exterior wall, and ashes formed by the incineration pass through the grate onto the floor for removal.

According to exemplary embodiments of the invention, the incinerator further includes a plurality of spray nozzles disposed adjacent the floor for spraying water on the floor.

According to exemplary embodiments, the incineration chamber is designed and configured for incineration between about 1200-1300° C.

There is also provided, according to the invention, a method for incinerating a fuel feed, the method including pre-heating a incineration chamber having a chamber wall having a first insulating material for retaining heat in the incineration chamber, the insulating material being mounted on the lower portion of the chamber wall, and a second insulating material for allowing a portion of the heat to radiate from the incineration chamber, the second insulating material being mounted on the upper portion of the chamber wall, pre-heating ambient air by means of heat from the upper portion of the chamber wall; introducing the partially heated ambient air into the incineration chamber; incinerating, in the incineration chamber, infeed fuel with the partially heated ambient air; removing hot gases from the incineration chamber via a heated hot gases space; and removing ashes through a grate onto a floor beneath the chamber.

According to exemplary embodiments, the method further includes spraying water onto the removed ashes on the floor, whereby the ashes are removed from the floor and a portion of the water evaporates and rises into the incineration chamber.

According to exemplary embodiments, the step of incinerating infeed fuel with the partially heated ambient air occurs at a temperature above 1000 C.

### DETAILED DESCRIPTION OF THE INVENTION

The present invention relates to an incinerator for converting feedstock or a wide range of fuel, particularly biomass, e.g., waste or refuse, including medical refuse, into gases (particularly, methane, nitrogen, and carbon dioxide gas) without smoke. This is accomplished using an incineration chamber or reactor configured to reach high temperatures, typically exceeding 1000° C., and preferably 1200-1300° C. The gasification process occurs in the incineration chamber. Air, that is partially heated on its way to the incineration chamber, together with steam (which can be created in the process of removing ashes), enhances the incineration and gasification process and, with the incinerated feedstock, create Methane (CH₄), Nitrogen (N) and Carbon Dioxide (CO₂). The Methane gas is preferably cleaned and separated from the other gases in a bio-gas generator or other device.

The fuel can be substantially any type of refuse or waste, including household waste and medical waste. Preferably, the waste does not include sludge, or other material with over 27% moisture. The incinerator is preferably cleaned after being used to incinerate glass and iron together with household waste, before further use. Medical waste can be incinerated safely in the incinerator of the invention due to the high temperatures of incineration, typically 1200-1300° C., that will be reached in the process.

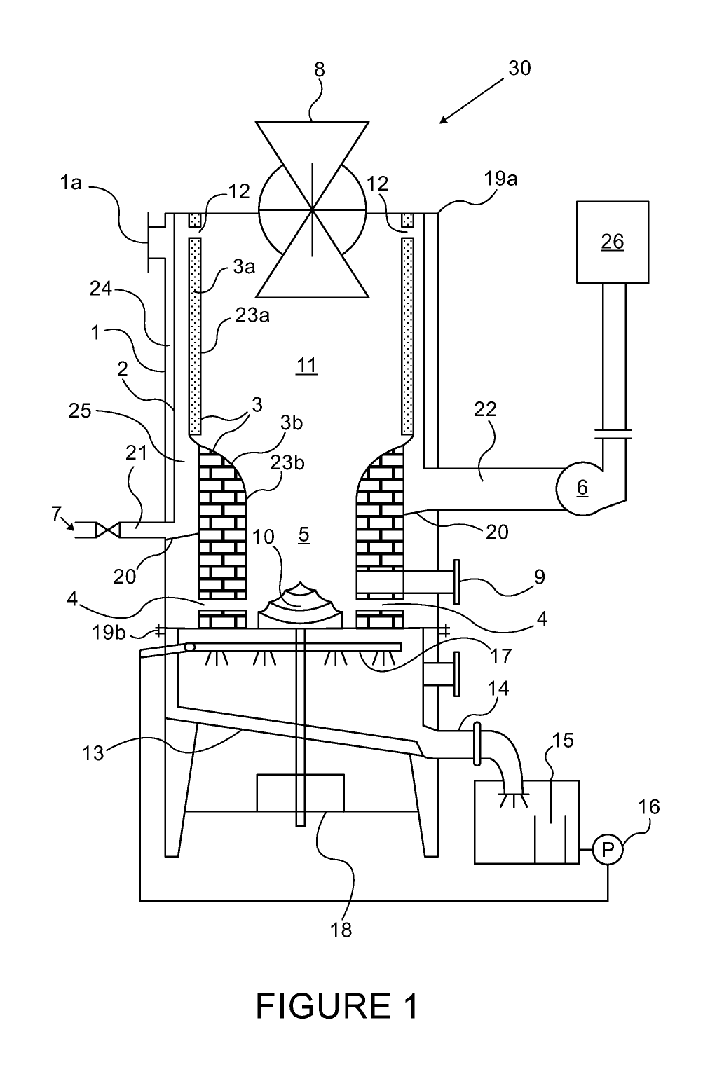

Referring now to FIG. 1, there is shown a schematic illustration of an incinerator 30, having an incineration chamber 5, constructed and operative according to one embodiment of the present invention. The incinerator 30 includes an infeed unit 8, preferably sealingly disposed in a top wall 19a of the incinerator 30, and arranged for feeding the fuel to incinerator 30. Alternatively, the infeed unit 8 can be sealingly disposed in a side wall of the incinerator. Infeed unit 8 opens into incineration chamber 5 and may include a rotating feeder or other mechanism for dividing the fuel into portions of predefined size. Infeed unit 8 is designed so that even while fuel is fed to the chamber, the incineration chamber 5 remains substantially sealed, to prevent the release of gases and heat from the chamber. Incineration chamber 5 also defines a space 11 for the collection of gases produced by the incineration process.

The incinerator 30 includes three walls or enclosures, an exterior wall 1, a middle wall 2, and an inner chamber wall 3. Exterior wall 1 includes at least one pipe or inlet la for the inflow of ambient air from outside the incinerator and into an air space 24 between walls 1 and 2. Middle wall 2 defines a space 25 for the removal of gases between walls 2 and 3. Chamber wall 3 is the wall of the incineration chamber 5. An annular bottom wall 19b defines the bottom limit of air space 24 and serves as the bottom wall of incineration chamber 5.

Middle wall 2 is disposed around chamber wall 3 defining gas collection space 25 therebetween. Gas space 25 is limited by an annular limiting wall 20 which is disposed between portions of walls 2 and 3. According to the embodiment illustrated in FIG. 1, limiting wall 20 is an angled or sloping annular wall 20. Limiting wall 20 serves two functions—to delimit the gas space 25 so that combustion gases can be removed from the incinerator and to lead to an outlet for liquid tar and other condensation products. Some of the gases produced in incineration chamber 5 (tar gas in particular) condense into liquid (e.g., liquid tar) inside gas space 25. Sloping wall 20 is configured for conducting and collecting these condensed liquids at the bottom of the slope, where a pipe 21 extends through middle wall 2 slope for conducting the gathered liquid away from the incinerator via an outlet 7. Thus, the liquid is drained from inside pipe 21 for disposal or possible use. Preferably, a gas outlet pipe 22 is also formed through middle wall 2, shown in this embodiment near the top of the slope of sloping wall 20. A suction blower 6 is disposed in gas pipe 22 for sucking the produced gases from incineration chamber 5, for example, to one or more storage tanks (not shown). A bio-gas generator 26 or other device is preferably connected to suction blower 6 for separating one gas, such as methane gas, from other gases. In some embodiments, the draining of liquids and the outflow of gases occurs through a single outlet pipe.

Chamber wall 3 includes two portions: an upper portion 3a and a lower portion 3b. Lower portion 3b is heavily insulated about its inner and/or outer surface with a first insulating material 23b for retaining heat inside the incineration chamber 5. A preferred heavy insulating non-combustible material 23b that lines lower portion 3b and retains substantially all the heat inside the chamber is firebricks or refractory insulation bricks that are covered with mineral wool or rock wool on one side. Upper portion 3a is more lightly insulated with a second insulating material 23a, preferably about its inner surface, for allowing a portion of the heat to radiate through the wall. Thus, insulation coating 23a is of a thickness or material that retains part of the heat inside incineration chamber 5, but also allows a part of the heat to radiate through wall portion 3a to heat the air in air space 24. In this way, upper portion 3a acts as a heat exchanger and the incoming air is heated thereby as it travels through air space 24 and remains hot as it enters the interior of the incinerator. The two insulating materials 23a and 23b may be the same material, but of different thicknesses, or may be different materials. It will be appreciated that the insulating materials may be coupled to or mounted on the chamber wall 3 in any conventional manner, such as by cement or mechanical attachment such as screws or bolts.

Wall 3 further defines at least one and preferably a plurality of heated air inlets 4 for partially heated ambient air to enter the lower portion 3b of the chamber 5. In addition, wall 3 also defines at least one and preferably a plurality of gas outlets 12 that open into gas space 25. It will be appreciated that, instead of being circumferential, the gas space 24 may be defined by a gas channel (not shown) coupled to the chamber wall 3 and the air space 25 may be defined by an air channel (not shown) coupled to the gas channel.

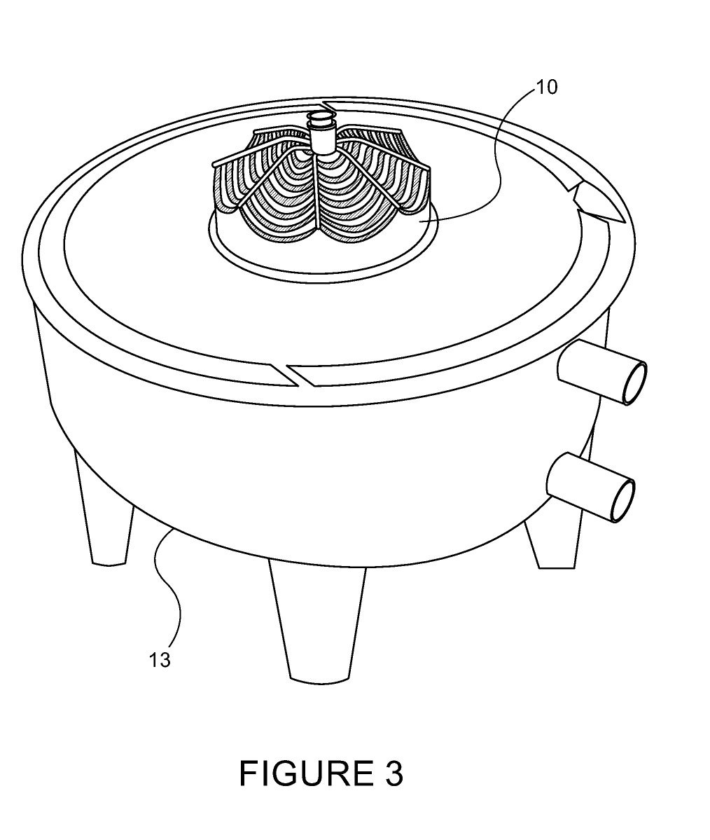

The incinerator 30 also includes a rotating grate 10 mounted on an axle, also seen in FIG. 3, disposed inside incinerator 30 at the lower portion 3b of incineration chamber 5. According to the embodiment shown in FIG. 1, rotating grate 10 is a slanted grill with at least one aperture. A motor 18 is coupled to the axle of rotating grate 10 to cause it to rotate. Rotating the rotating grate 10 will cause any fuel on top of it to be mixed, turned over, or churned during incineration. Grate 10 preferably includes concave, arcuate slats between radial ridges and the apertures are concave, curving apertures, as best seen in FIG. 3. Rotating grate 10 is disposed in an ashes outlet in bottom wall 19b of incineration chamber 5 above an inclined floor 13. The apertures in grate 10 are designed to permit the passage of ashes to inclined floor 13. In the embodiment of FIG. 1, floor 13 is an inclined floor that slopes towards an ashes and water exit opening 14 for facilitating the removal of ashes. Inclined floor 13 is also preferably lined with insulating materiel (preferably the same as 23b), such as firebricks or refractory insulation bricks (not shown) to prevent the escape of heat from the incinerator 30. At least one, and preferably a plurality of water sprayers 17 are disposed beneath the incineration chamber 5 for spraying water onto the inclined floor 13 and thereby creating steam to enhance the incineration process while urging the ashes towards the opening 14.

When the incinerator is operating, a portion of the water sprayed from the sprayers 17 will vaporize to steam, due to the heat inside the incineration chamber 5 and on inclined floor 13. Some of this steam will rise through the apertures in rotating grate 10 and into the incineration chamber 5.

In the embodiment of FIG. 1, ash and water exit opening 14 opens to an ash separation and water collection system 15. Ash separation and water collection system 15 separates the water from the ashes. The system 15 is connected to a water recirculation pump 16 for returning the separated water to the sprayers 17 for re-use. The water and/or ashes may be removed by suction, such as a vacuum pump, by mechanical means, such as a conveyor belt, or by any other conventional means.

Preferably, a pipe 9 is disposed through walls 1, 2, and 3 to act as a service opening 9 to access the incineration chamber 5 from beyond the exterior wall 1. Service opening 9 provides access to kindling in the incineration chamber to permit a user to ignite a preliminary quantity of fuel in order to start the incineration process. The incineration process can be started in any conventional manner appropriate for the operation of the incinerator 30. A heating element (not shown), for example, an electric heater or lighter, is preferably provided to provide initial heating of the incinerator 30 by igniting the preliminary quantity of fuel, until the temperature inside the incineration chamber 5 has reached the temperature suitable to begin incineration of the feed. Service opening 9 can also function as a waste service opening used to remove heavy elements, e.g. pieces of metal, that didn't burn completely in the incineration process.

The method of operating the incinerator 30, according to one embodiment of the invention, is as follows:

A preliminary quantity of fuel is fed through the infeed unit 8 into incinerator 30. This fuel is ignited manually through service opening 9 or automatically by a heating element. The ignited fuel begins to heat the interior of incineration chamber 5. Heat is retained inside the incineration chamber 5 by the insulation layers (for example, refractory insulation bricks 23b and light insulation coating 23a). Air passes through ambient air inlet la into air space 24 (the space between walls 1 and 2). The heat in the incineration chamber creates a vacuum which causes an inflow of air into incinerator 30 through exterior air inlets la. When passing through the air space 24 between walls 1 and 2, the air is heated by the heat radiating from the lightly insulated upper portion 3a of wall 3. The partially heated air will then pass through at least one air inlet 4 disposed in the lower portion 3b of wall 3 into the incineration chamber 5. The inflow of air is not forced or artificial and occurs due to the air pressure differential created during the incineration process.

At the same time, water sprayers 17 spray water onto inclined floor 13. Steam is generated from the water contacting the heated surface of inclined floor 13 and the heat from incineration chamber 5. This steam rises through the apertures in grate 10 into chamber 5, further raising the temperature in chamber 5. The raised temperature allows the fuel to be incinerated more rapidly, and helps ensure no smoke is released throughout the incineration process. It will be appreciated that the steam in the incineration chamber, together with the products of the combustion of the infeed fuel, creates the gases that are the final products.

The preliminary heating of the incinerator 30 is continued by the incineration of fuel in the chamber 5 in the presence of the pre-warmed air and steam, as described above. The temperature inside the chamber 5 continues to rise until the interior of the incineration chamber 5 reaches the desired temperature for incineration of the fuel, typically between 1200-1300° C. It will be appreciated that this process is smoke free, so there is no pollution during incineration, which is true for all operations of the incinerator.

Once the desired temperature has been reached, additional fuel is fed into the incineration chamber in a controlled manner, preferably in substantially equal sized predefined portions (units), through the infeed unit 8 into the incineration chamber 5. However, if necessary, additional fuel may be added even before the interior of the incineration chamber 5 reaches the desired temperature (i.e. even before it reaches 1200° C.).

The fuel that is fed into the incinerator 30 is incinerated and part of it is converted to gas (gasified) due to the high temperature inside incineration chamber 5. Motor 18 rotates rotating grate 10, which turns and mixes any un-combusted fuel to help facilitate its combustion. The ashes that are created pass through the apertures in the rotating grate 10 and fall onto inclined floor 13. These ashes are washed from inclined floor 13 by the water that is sprayed from the water sprayers 17. The ashes are washed along and down inclined floor 13 through opening 14 to the ash separation system 15. Ash separation system 15 separates the water from the ashes. The separated ashes can be removed and disposed of. The separated water may be returned to the washing process by water pump 16.

As the fuel is incinerated, various incineration gases are released, most of which are, themselves, incinerated in the chamber. Due to the high temperatures, mainly methane, nitrogen, carbon dioxide, and tar in the form of gas (tar gas), remain. These remaining, un-incinerated gases rise to and collect in space 11 in the upper portion of incinerator 30 and create a layer of gases that traps heat underneath it. In this way, the heat released by the incineration process is further trapped within the incineration chamber 5, thereby facilitating the high temperatures in the chamber. A portion of the combustion gases (methane, nitrogen, carbon dioxide and tar gas) that rise from the incineration chamber 5, will exit from space 11 through gas outlets 12 to gas space 25 between walls 2 and 3, typically drawn from the space 11 by the suction blower 6 for later use. Inside gas space 25, the tar gas cools down and condenses into liquid tar. This liquid tar drains downwards by means of gravity along the slope wall 20 and out through pipe 21 to the liquid drain opening 7. From there it can be returned to incineration chamber 5 as fuel for incineration.

In some embodiments, the methane is separated from the other gases by a bio-gas generator 26 or other device.

### EXAMPLE

One example of a commercial incinerator constructed and operative in accordance with one embodiment of the invention was built as follows: a cylindrical incineration chamber having a height of 3.02 meters and a diameter of 1.52 meters, with a lower portion 0.98 meters high lined with firebricks, and an upper portion 0.98 meters high lined with a light isolation coating, was built. This incinerator operated at temperatures between 1200-1300° C. and was capable of incinerating 150-250 kilograms per hour of waste.

It will be appreciated that the invention is not limited to what has been described hereinabove merely by way of example. Rather, the invention is limited solely by the claims which follow.

1. An incinerator comprising:
an incineration chamber;
a chamber wall having a first insulating material for retaining heat in the incineration chamber, said insulating material being mounted on the lower portion of said chamber wall, and a second insulating material for allowing a portion of the heat to radiate from the incineration chamber, said second insulating material being mounted on the upper portion of said chamber wall, said chamber wall further defining at least one hot air inlet for allowing hot air to enter the incineration chamber and at least one incineration gases outlet for allowing hot gases to exit from the incineration chamber;
a dividing wall disposed around said chamber wall, thereby defining a gas space between said chamber wall and said dividing wall, and at least one gas outlet for allowing hot gas to pass from the gas space;
an exterior wall disposed around said dividing wall, thereby defining an air space between said dividing wall and said exterior wall, said exterior wall further defining at least one ambient air inlet for allowing ambient air to enter the air space, said chamber wall further defining at least one hot air inlet for allowing hot air to pass from an air space to the incineration chamber;
a sealable feeding fuel inlet;
a bottom wall defining an ashes outlet;
a first limiting bottom wall disposed between portions of the chamber wall and the dividing wall for limiting said gases space;
a second limiting bottom wall disposed between portions of the dividing wall and the exterior wall for limiting said air space;
a grate disposed in said ashes outlet in the said bottom wall for allowing ashes to pass therethrough;
a floor disposed under said grate for collecting the ashes for removal; wherein,
fuel fed through said fuel inlet is incinerated in the incineration chamber, ambient air entering said air space, which is heated by said chamber wall, enters the incineration chamber through said hot air inlet in said chamber wall and contributes to the incineration process, incineration gases which are formed by the incineration exit the incineration chamber into said gases space through said incineration gases outlet in said chamber wall, exit the gases space for collection through said gas outlet in said chamber wall and said gas outlet in said exterior wall, and ashes formed by the incineration pass through said grate onto said floor for removal.

2. The incinerator according to claim 1, further comprising a plurality of spray nozzles disposed adjacent said floor for spraying water on the floor.

3. The incinerator according to claim 1, wherein said grate is a rotating grate.

4. The incinerator according to claim 2, wherein said grate is a rotating grate.

5. The incinerator according to claim 1, wherein said incineration chamber is designed and configured for incineration between about 1200-1300° C.

6. The incinerator according to claim 2, wherein said incineration chamber is designed and configured for incineration between about 1200-1300° C.

7. A method for incinerating a fuel feed, the method comprising:
pre-heating a incineration chamber having a chamber wall having a first insulating material for retaining heat in the incineration chamber, said insulating material is mounted on the lower portion of said chamber wall, and a second insulating material for allowing a portion of the heat to radiate from the incineration chamber, said second insulating material is mounted on the upper portion of said chamber wall,
pre-heating ambient air by means of heat from said upper portion of said chamber wall;
introducing said partially heated ambient air into the incineration chamber;
incinerating, in said incineration chamber, infeed fuel with said partially heated ambient air;
removing hot gases from the incineration chamber via a heated hot gases space; and
removing ashes through a grate onto a floor beneath the chamber.

8. The method according to claim 7, further comprising spraying water onto said removed ashes on the floor, whereby the ashes are removed from the floor and a portion of the water evaporates and rises into the incineration chamber.

9. The method according to claim 7, wherein said step of removing ashes includes causing said grate to rotate to complete incineration and permit ashes to fall through the grate.

10. The method according to claim 8, wherein said step of removing ashes includes causing said grate to rotate to complete incineration and permit ashes to fall through the grate.

11. The method according to claim 7, wherein said step of incinerating infeed fuel with said partially heated ambient air occurs at a temperature above 1000 C.

12. The method according to claim 8, wherein said step of incinerating infeed fuel with said partially heated ambient air occurs at a temperature above 1000 C.
